(19) United States
(12) Patent Application Publication
(10) Pub. No.: US 2015/0322243 A1
(43) Pub. Date: Nov. 12, 2015

(54) FILLER MIXTURE FOR THE PRODUCTION OF THERMOPLASTIC SHOE REINFORCEMENT MATERIALS

(71) Applicant: BK Giulini GMBH, Ludwigshafen (DE)

(72) Inventors: Henriette Jaerger, Heuchelheim (DE); Markur Fiebiger, Grossniedeshiem (DE); Werner Busalt, Viernheim (DE)

(21) Appl. No.: 14/410,428

(22) PCT Filed: Jun. 27, 2013
(86) PCT No.: PCT/EP2013/001894

§ 371 Date: Dec. 22, 2014

(30) Foreign Application Priority Data
Jul. 5, 2012 (DE) 10 2012 013 432.0

(51) Int. Cl. C08K 11/00; C08K 3/00

(52) U.S. Cl. CPC C08K 11/005; C08K 3/0033

(57) ABSTRACT

The present invention relates to a filler mixture made from a bioplastic and a specially selected, renewable natural material, specifically a material consisting of rice husk powder in a volume of up to 50% by weight and polylactic acid powder of up to 70% by weight, which is suitable for the production of thermoplastic reinforcement materials for the footwear industry, primarily for toe caps and counters. Shoe reinforcement materials using the filler mixture according to the invention can be produced both on a double belt system and by extrusion, particularly by coextrusion.

The present invention relates to a filler mixture for the production of thermoplastic reinforcement materials for the shoe industry, above all for toe caps and counters or rear caps.

The powder mixture consists of a bioplastic and a specially selected renewable natural material.

The production of shoe reinforcement materials with the filler mixture according to the invention can be realized with a double belt system, as well as with the aid of extrusion, in particular also co-extrusion.

Reinforcement materials are described in the DE 26 21 195 C which are produced in the form of flat sheet goods/panel goods. In the process, a textile-like carrier material is coated with powdered, meltable plastic material which also contains fillers. Polyethylene, vinyl acetate and their copolymers are used for the meltable plastic materials while wood flour, for example, or chalk powder are used as suitable fillers. The goal of the invention was to increase the share of filler materials in the coating while still maintaining the bending strength and rigidity of the material. It was found that the share of the filler can be increased in a volume up to 50% if the grain-size distribution of plastic and filler powder is similar or comparable. The melted plastic particles in the process can completely surround the filler particles, so that the filler materials also behave in the manner of plastics. These materials do not have sufficient adhesive properties and must therefore be provided with an adhesive coating applied to the surface, so that they can bond permanently with the shoe uppers.

Shoe reinforcement materials were described in the EP 183 912 B2 which can be glued directly to the shoe leather, without additional adhesive. Hot melt adhesives in the form of polycaprolactones were used therein, which were particularly suitable because of their low melting point of approximately 60° C. The fillers used were plastic powders or plastic-encased organic or inorganic powders which did not dissolve in the hot-melt adhesive. Depending on the requirement, these materials were also provided on one side or both sides with a carrier material.

The disadvantage of the known materials was the frequent necessity of using a carrier material to obtain the bonding and cohesion of the material at higher temperatures, so as to obtain and/or achieve the required strength in the warm state for the machine-production of the composite shoe. Since the shoe caps are produced from the flat webs through punching and scarfing, waste material is always generated by the punching and scarfing. Owing to the carrier material residues which still adhere, this waste material could not be returned to the production process.

According to EP 1 525 284 B1 in which a hot-melt adhesive/filler mixture compound is described, some of the above-described disadvantages could be overcome. Owing to the precisely adjusted physical parameters, such as the melt volume index, length expansion, viscosity, surface stickiness or also “tack,” this hot-melt adhesive/filler mixture compound among other things had enough inherent stability to be processed without carrier material. This was achieved through the precise adjustment of the aforementioned parameters for the raw materials used. Thus, the hot-melt adhesive had to have a MVI value (measured at 100° C., 21.6 kg according to DIN ISO 1133) of 2-300, preferably 10-30 cm³/10 min. The quantitative ratio of hot-melt adhesive to filler material furthermore had to be 50-95% by weight, relative to 50-5% by weight of the filler. The fillers used in this case were spherical, many-edged particles with a grain size of 10-500 μm, either organic, natural or also inorganic mineral fillers. Flat webs were produced from these materials as well, e.g. following an extrusion, from which the three-dimensional reinforcing parts could be produced through punching and scarfing, wherein the scarfing and punching waste materials had the same composition as the original materials and could therefore be re-introduced without problem into the extruding process. However, these materials had the disadvantage of a comparatively high share of hot-melt adhesive to make possible the inner cohesion of the compound. Especially at higher temperatures and with low amounts of the hot-melt adhesive, the materials could separate in longitudinal direction or they could become brittle following the cooling down and/or hardening.

The document TW 201008765 disclosed a method for producing ecofriendly running soles which contained recycled rice husks, wheat spelt and similar plant materials as admixture. These raw materials are strained, are then mixed uniformly in a machine with natural rubber, and are formed into ecofriendly sheets of material with corresponding thicknesses. A material for rubber running shoe soles is thus produced which contains rice husk granulate and has excellent physical properties. With this production method, ecofriendly running shoe soles with good use characteristics could be produced.

TW 45548 B relates to a “shoe production method with rice husks,” which primarily contains in addition to the rice husks a Styropor® waste material at a share of up to 13% by weight of the total footwear.

According to WO 2011/098842, polylactic acid and derivatives thereof were produced for an ecofriendly and biologically degradable packaging material, which was used above all by the food industry. The composition of polymers, such as thermoplastic polyhydroxyalkanoates (PHA) and polyhydroxybutyrates (PHB) and inorganic filler, e.g. nano-calcium carbonate, as well as organic fillers such as powdered straw, sugar cane leaves, palm leaves or rice husks with a grain size up to 20 μm, showed improved thermal insulation capability. A typical composition, for example, consisted of 71% polylactic acid (PLA), 9% PHB and 20% nano-calcium carbonate. These materials were not suitable for use as thermoplastic shoe reinforcement materials.

The object therefore was to find additional, improved shoe reinforcement materials for the production of shoe caps, as well as suitable productions methods therefor. These shoe reinforcement materials should have good biological degradability and recyclability in addition to having improved bending strength, length expansion, surface stickiness and peeling resistance. Above all, it should be possible to produce the materials economically and ecologically.

The object thus primarily was to find suitable filler mixtures as raw materials which on the one hand are naturally renewable resources, in particular of a plant origin and, on the other hand, also contain bioplastics, wherein both should be usable as filler materials in amounts up to 75% by weight, relative to the share of hot-melt adhesive, without rendering the finished thermoplastic reinforcing material unstable during the intermingling and processing, above all to prevent it from falling apart under the influence of heat.

Surprisingly, the above-mentioned object could be solved with a filler mixture which is also compatible with the known hot-melt adhesives. This mixture is composed of the bioplastic, that is polylactic acid powder and/or recycled polylactic acid powder (polylactic acid or PLA), and a specially selected plant fiber, namely cleaned rice husks. In addition to using the conventional powder-coating technique on a double belt system, extrusion or co-extrusion in a multi-channel extruder have proven to be especially successful production methods, wherein these methods allow processing the inventive filler combination in amounts of up to 75% by weight, without losing the required material properties, such as the thermal stability, bending strength and surface stickiness in the process. On the contrary, the products produced in this way comprise all properties required in practice and are therefore especially suitable as shoe reinforcement materials, meaning as shoe caps.

The filler component polylactic acid, or the recycled polylactic acid, henceforth referred to as PLA or r-PLA, are highly biodegradable. PLA is being used in the industry for numerous different applications. Known applications for PLA are in the packaging industry, the food industry, in agriculture, gardening, medical technology, for sports clothes and functional clothes, and as compound materials. PLA belongs to the bioplastics, but is also a renewable resource because the lactic acid is initially obtained from sugar and corn starch and because the polylactic acid is subsequently produced from these with the aid of polymerization.

Bioplastics are not a uniform class of polymers, but include a large family of very different types of plastics. The term is understood in different ways. On the one hand, bioplastics are understood to be biodegradable plastics while, on the other hand, they are understood to be plastics primarily produced on the basis of raw agricultural materials. In most cases, the two definitions will overlap.

A special feature of the PLA is that it is highly biodegradable under special environmental conditions in industrial composting plants. Under industrial composting conditions, the decomposition takes place within a few months.

Within the framework of the present invention, a recycled polylactic acid, r-PLA, in powdered form is preferred.

Both fillers, PLA and/or r-PLA, as well as the rice husks, form an advantageous filler mixture in combination with the thermoplastic hot-melt adhesives already being used for the shoe production, such as polycaprolactones (Capa™ types) or thermoplastic polyurethanes (TPUs) or ethylene vinyl acetates (EVA). The filler mixture is compatible with all these substances, but also with many other thermoplastic hot-melt adhesives and can without problem be processed into foils and films, flat webs, or panels. These materials can optionally also be coated on one side or both sides with a carrier material.

These flat webs, panels or foils can subsequently be stamped into preforms in a clicker press and, as such, can be used in the shoe production as three-dimensional preforms for rear caps or front caps. The rice husks, which are naturally renewable plant materials, are obtained by peeling the rice grain and can also be used without drying, if applicable, for the filler materials.

The raw materials used according to the invention have the following physical properties:

a. Poly-ε-caprolactones or polycaprolactone-based polyurethanes in powdered form, with a molecular weight of 40,000-80,000 g/mol, a MFI value between 2.5 and 31, depending on the type measured at 100 and/or 160° C./2.16 kg, with a grain size distribution ranging from 50 to 1000 μm.
b. Thermoplastic polyurethanes or TPUs in powdered form with a melt flow index (MFI) of 10-50 g/10 min—preferably 25-40 g/10 min (at 190° C./2.16 kg)—the grain size ranges from 50 to 1000 μm.
c. Ethylene vinyl acetate copolymer (EVA) in powdered form, having a MFI=20-50 g/10 min+a VA share (vinyl acetate share) of 20-40% by weight; the grain size distribution ranges from 50 to 1000 μm.
d. Rice husks—powder with a grain size ranging from 1 to 3000 μm, preferably 20-800 μm.
e. Polylactic acid powder and/or r-PLA powder with a MFI=2-40 g/10 min at 190° C./2.16 kg; having a grain size distribution of 50 to 1000 μm and a residual moisture content of maximum 2500 ppm.
f. The carrier materials can either be a water jet reinforced, perforated/non-perforated polyester nonwoven, having an area density of 25-120 g/m² or a cotton fabric and/or a cotton-blend fabric with an area density of 25-120 g/m².

The use of a carrier material is always optional.

The measuring of the melt flow index (MFI) occurs in accordance with the guidelines of the DIN EN ISO 1133.

The bending strength of the tested products was measured according to DIN EN ISO 20864 (Dom test).

The following examples further illustrate the invention, without the invention being restricted solely to these examples.

The thermoplastic reinforcement materials according to the invention can be produced with the aid of extrusion or co-extrusion, but also by means of a powder coating technique on a double belt system.

### EXAMPLES FOR THE PRODUCTION ON A DOUBLE BELT SYSTEM

The shares of the powdered raw materials, meaning the rice husks and the r-PLA, were mixed ahead of time to form a homogeneous powder mixture, if applicable also agglomerated. This mixture is processed on a double belt system.

The double belt system consists of an endlessly circulating upper belt and a lower belt of the same type, with an adjustable gap forming between the two belts. The powder mixture is deposited into this gap and is turned into a film with the aid of specified pressure and temperature values. The heat for the filming of the product is generated by heating panels. Turning the powder into a film means that the mixture is melted-on during a continuous process, is then pressed into the flat mold and, following the cooling down, is allowed to harden.

If there is a need to provide the material on one side or both sides with a carrier material, the powder mixture can be deposited directly or onto a carrier material and can thus be processed.

The difference to the double belt system is that the heat is generated by a heat radiator or infrared radiator and that the powder is compacted with calendar rolls in place of the upper or lower belt. The measuring values for the reinforcement materials produced with the double belt system follow from Table 1.

The following inventive compositions were tested:
1. 50 weight—rice husk agglomerate powder, composed of 50% by weight rice husks with 50% by weight EVA powder, as well as 15% by weight poly caprolactone powder and 10% by weight EVA powder, with 25% by weight r-PLA powder, all mixed together homogeneously.
2. 25% by weight rice husk agglomerate powder with 25% by weight r-PLA powder were mixed homogeneously with 5% by weight EVA powder and 45% by weight polycaprolactone powder.

For a comparison, the compositions according to the Patent WO 2011/098842 were measured in the same way as the inventive compositions.

### Examples for Producing the Reinforcement Material According to the Invention with the Extrusion or Co-Extrusion Method

Simple extrusion as well as co-extrusion can be used advantageously for the production of shoe reinforcement materials.

The examples and/or the recipes introduced below can be used with both methods.

Accordingly, the cleaned rice husks and the r-PLA, if applicable, in amounts of 50 to 75% by weight, as well as the thermoplastic hot-melt adhesives in amounts of 25 to 50% by weight, can be subjected jointly to a pre-agglomeration.

### Production Example 1

15% by weight of thermoplastic polyurethane with a MFI value of 1-25 g/10 min, measured at 150° C., 10 kg; 10% by weight ethylene vinyl acetate copolymer with a VA content of 20 to 40% by weight, and 20% by weight linear polyester poly-ε-caprolactone with a molecular weight distribution of 40 to 80,000, as well as 40% by weight of recycled polylactic acid powder and 15% by weight of rice husk powder with a grain size of 400 to 800 μm are pre-agglomerated and then processed further in the extruder.

### Production Example 2

10% by weight ethylene vinyl acetate copolymer with a VA content of 20 to 40% by weight and 40% by weight linear polyester poly-ε-caprolactone with a molecular weight distribution of 40 to 80,000 are pre-agglomerated together with 35% by weight recycled polylactic acid powder and 15% by weight rice husk powder and are then processed further in the extruder.

### Production Example 3

20% by weight thermoplastic polyurethane with a MFI value of 1-25 g/10 min, measured at 150° C., 10 kg; 10% by weight ethylene vinyl acetate copolymer with a VA content of 20 to 20% by weight are pre-agglomerated together with 45% by weight recycled polylactic acid powder with a MFI (melt flow index) of 15-35 g/10 min and 15% by weight rice husk powder having a grain size of 350 to 700 μm and the mixture processed further in the extruder.

### Production Example 4

50% by weight rice husk agglomerate, obtained as agglomerate from 50% by weight rice husks and 50% by weight EVA, as well as an additional 10% by weight EVA and 25% by weight r-PLA granulate and 15% by weight polycaprolactone.

### Comparison Examples

### Comparison Example 1

25% by weight ethylene vinyl acetate copolymer with a VA content of 20 to 40% by weight and 45% by weight linear polyester poly-ε-caprolactone having a molecular weight distribution of 40 to 80,000 are mixed with 30% by weight wood flour having a bulk density of approximately 25 g/ml and a residual moisture content of less than 9% and are then processed further in the extruder.

### Comparison Example 2

10% by weight of ethylene vinyl acetate copolymer with a VA content of 20 to 40% by weight and 60% by weight of linear polyester poly-ε-caprolactone having a molecular weight distribution of 40 to 80,000 are mixed with 30% by weight wood flour having a bulk density of approximately 25 g/ml and a residual moisture content of less than 9% and are then processed further in the extruder.

If the co-extrusion method is used for the production of the reinforcement materials according to the invention, the machine of choice is a multi-channel extruder.

For the co-extrusion, several melt flows with different throughputs (layer thicknesses) and different flow properties must initially be fed into a joint flow channel and then flow jointly through this channel. During the combining of the individual melt layers and the joint flowing of the melt layers following the combining, so-called flow phenomena can occur which can lead to problems with the co-extrusion.

For that reason, a multi-channel tool must be used for the production of the reinforcement materials according to the invention.

With a multi-channel tool, each melt layer is formed in a separate flow channel. The melt distribution of each individual layer can be corrected across the width by means of restrictor bars. The individual melt flows do not merge until the ironing region, meaning the region shortly before the melt exits from the nozzle. The thickness distribution of the total compound can be corrected by adjusting the exit gap.

The relatively short flow distance for the total layer in the discharge region is advantageous for avoiding melt rearrangements and/or the flowing into each other of the melt layers. Under this aspect, the production according to the invention of reinforcing materials having different layer thicknesses, as well as of material combinations that differ greatly in the flow properties can be realized optimally with a multi-channel tool.

For this application, a multi-channel tool with 3 channels should be used.

The end product following the co-extrusion is composed of 3 layers, consisting of a “core” of the filler mixture, specifically of rice husks and r-PLA, as well as hot-melt adhesive, and 2 outer adhesive layers of the thermoplastic hot-melt adhesive.

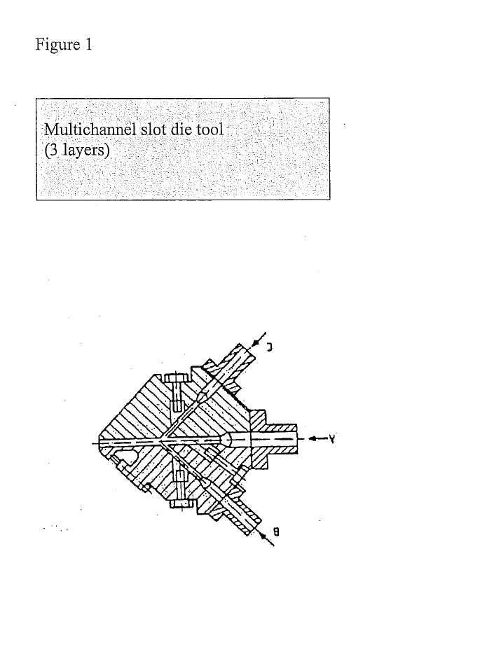

The core, which is the melt flow in FIG. 1, can thus be composed of 50% by weight of r-PLA and 25% by weight of rice husks, as well as 25% by weight of EVA, and the two sticky outer layers, according to FIG. 1 the melt flows B and C, can be composed of EVA, thermoplastic polyurethanes or polyesters, e.g. polycaprolactones, which are jointly applied to the surface of this core in an amount of approximately 10 to 250 g per m². The thickness of these sticky layers can range from 0.1 to 2 μm. The filler mixture that forms the “inner core” can also be pre-agglomerated prior to the extrusion.

The co-extrusion is particularly advantageous if the inner core contains up to 75% by weight of the filler mixture because the amount of hot-melt adhesives in the core can thus be lowered, thereby resulting in considerable economic advantages. The quantitative ratio of (filler in the core):(adhesive in the core) can therefore be up to 3:1.

The material composition of the core, the 3-layer configuration, and the variation of the layer thickness and/or the amount of adhesive in the outer layers make it possible to realize different rigidities and bending strengths, as needed, and has furthermore advantages for the installation and handling of the shoe caps in the shoe during the shoe production.

An example of a so-called multi-channel extruder is presented in FIG. 1.

TABLE 1

| | | | | | | Dom test | | |
|---|---|---|---|---|---|---|---|---|
| | | | | | | Surface shape | | |
| | | | Bending | Strain | | Holding value | | Peeling |
| | Thickness | Weight | resistance | values [N] | Elongation | (after 10x | indentation | values |
| Recipes | [mm] | [g/m²] | [mN] | (10 × 2) | [%] | Pressing) | load | [N/cm] |
| Acc. to | 1.03 | 1213-1217 | 4844-4900 | 550-650 | 2.5-3.6 | 68% | 18N | 0.0N |
| WO2011/098842 | | | | | | | | |
| Acc. to | 1.01 | 1190-1210 | 5800-5825 | breaks | cannot be | breaks | breaks | 0.0N |
| WO2011/098842 | | | | | measured | | | |

Recipes according to the invention

| | | | | | | | | |
|---|---|---|---|---|---|---|---|---|
| Example 1 | 1.10 | 1177 | 1810-1911 | 211-252 | 2.4-3.1 | 64% | 108N | 13-15 |
| Example 2 | 1.00 | 1028 | 1300-1440 | 340-350 | 10-10.5 | 61% | 88N | 18-20 |

TABLE 2

| | | | | | | Dom test | | |
|---|---|---|---|---|---|---|---|---|
| | | | | | | Surface shape | | |
| | | | Bending | Strain | | Holding value | | Peeling |
| | Thickness | Weight | resistance | values [N] | Elongation | (after 10x | indentation | values |
| Recipes | [mm] | [g/m²] | [mN] | (10 × 2) | [%] | Pressing) | load | [N/cm] |
| Comparison | 1.1 | 1128-1147 | 851-852 | 265-272 | 15-20 | 57% | 69N | 11N-13N |
| example 1 | | | | | | | | |
| Example 1 acc. | 1.1 | 1200-1238 | 771-896 | 260-268 | 15-20 | 72% | 71N | 12N-15N |
| to invention | | | | | | | | |
| Example 4 acc. | 1.10 | 1177 | 1810-1911 | 250-260 | 10-15 | 81% | 108N | 13N-15N |
| to invention | | | | | | | | |
| Comparison | 1.1 | 1120-1166 | 1095-1137 | 260-270 | 10-12 | 74% | 88N | 13N-15N |
| example 2 | | | | | | | | |
| Example 2 acc. | 1.1 | 1170-1185 | 1346-1353 | 281-289 | 10-12 | 89% | 88N | 14N-20N |
| to invention | | | | | | | | |
| Example 3 acc. | 1.03 | 1116-1139 | 1003-1067 | 313-328 | 17-19 | 72% | 86N | 14N-20N |
| to invention | | | | | | | | |

1. A filler mixture for the production of thermoplastic shoe reinforcement materials, comprising:
rice husk powder in a volume of up to 50% by weight; and
polylactic acid powder in a volume up to 70% by weight,
wherein the thermoplastic shoe reinforcement materials include thermoplastic hot-melt adhesives and can be produced by means of extrusion and/or co-extrusion.

2. A filler mixture for the production of thermoplastic shoe reinforcement materials, comprising:
rice husk powder in a volume of up to 50% by weight; and
polylactic acid powder in a volume of up to 70% by weight,
wherein the thermoplastic shoe reinforcement materials include thermoplastic hot-melt adhesives and can be produced with a method using a double belt system, wherein they can be provided on one side or both sides with a carrier material.

3. The filler mixture of claim 1, wherein the thermoplastic hot-melt adhesives are selected from a group consisting of linear polyesters up to 50% by weight, ethylene vinyl acetates copolymers up to 30% by weight, and thermoplastic polyurethanes up to 50% by weight and/or mixtures of these plastics.

4. The filler mixture of claim 1, further comprising inorganic fillers in maximum amounts up to 1% by weight.

5. The filler mixture of claim 1, wherein the rice husk powder has a grain size distribution ranging from 1-3000 μm.

6. The filler mixture of claim 1, wherein the polylactic acid powder is a recycled polylactic acid powder.

7. (canceled)

8. The filler mixture of claim 5, wherein the rice husk powder has a grain size distribution ranging from 20-800 μm.

9. The filler mixture of claim 2, wherein the thermoplastic hot-melt adhesives are selected from a group consisting of linear polyesters up to 50% by weight, ethylene vinyl acetates copolymers up to 30% by weight, and thermoplastic polyurethanes up to 50% by weight and/or mixtures of these plastics.

10. The filler mixture of claim 2, wherein the rice husk powder has a grain size distribution ranging from 1-3000 μm.

11. The filler mixture of claim 10, wherein the rice husk powder has a grain size distribution ranging from 20-800 μm.

12. The filler mixture of claim 2, wherein the polylactic acid powder is a recycled polylactic acid powder.

13. A method of using the thermoplastic shoe reinforcement materials of claim 1, comprising applying the filler mixture to a shoe part.

14. A method of using the thermoplastic shoe reinforcement materials of claim 2, comprising applying the filler mixture to a shoe part.

15. A thermoplastic shoe reinforcement materials manufactured from the filler material of claim 1.

16. A thermoplastic shoe reinforcement materials manufactured from the filler material of claim 2.
